(19) United States
(12) Patent Application Publication
(10) Pub. No.: US 2014/0285514 A1
(43) Pub. Date: Sep. 25, 2014

(54) STORAGE MEDIUM HAVING STORED THEREIN INFORMATION PROCESSING PROGRAM, INFORMATION PROCESSING SYSTEM, INFORMATION PROCESSING APPARATUS, AND INFORMATION PRESENTATION METHOD

(71) Applicant: NINTENDO CO., LTD., Kyoto (JP)

(72) Inventor: Toshiaki SUZUKI, Kyoto (JP)

(73) Assignee: NINTENDO CO., LTD., Kyoto (JP)

(21) Appl. No.: 14/035,419

(22) Filed: Sep. 24, 2013

(30) Foreign Application Priority Data
Mar. 21, 2013 (JP) 2013-057960

(51) Int. Cl. G09G 5/377

(52) U.S. Cl. CPC G09G 5/377
USPC 345/629

(57) ABSTRACT

An example of an information processing system presents information together with a virtual space such that the information is associated with a position within the virtual space. The information processing system displays some of pieces of presentation information associated with positions within the virtual space, in a first display region. The presentation information displayed in the first display region is changed in accordance with an input by a user. The information processing system selects some of the plurality of pieces of presentation information. In this case, the presentation information to be selected is changed in accordance with change of a display of the presentation information in the first display region. The information processing system displays, in a second display region different from the first display region, the selected presentation information together with the virtual space such that the selected presentation information is associated with positions within the virtual space.

### CROSS REFERENCE TO RELATED APPLICATION

The disclosure of Japanese Patent Application No. 2013-57960, filed on Mar. 21, 2013, is incorporated herein by reference.

### FIELD

The technology herein relates to an storage medium having stored therein an information processing program, an information processing system, an information processing apparatus, and an information presentation method, for presenting information together with a virtual space such as a map.

### BACKGROUND AND SUMMARY

Hitherto, there is a technology in which a map is displayed and information is added and displayed on the map.

When a lot of information is added and presented on a virtual space such as a map, it is difficult to present the information such that the information is easily viewable in some cases.

Therefore, the present application discloses a storage medium having stored therein an information processing program, an information processing system, an information processing apparatus, and an information presentation method which allow information presented together with a virtual space to be displayed such that the information is easily viewable.

(1) An example of a storage medium described in the present specification is a computer-readable non-transitory storage medium having stored therein an information processing program executed by a computer of an information processing apparatus for presenting information together with a virtual space such that the information is associated with a position within the virtual space. The information processing program causes the computer to execute: changing the presentation information displayed in a first display region, in accordance with an input by a user; changing presentation information to be selected; and displaying the selected presentation information in a second display region.

The computer displays some of a plurality of pieces of presentation information associated with positions within the virtual space, in a first display region, and changes the presentation information displayed in the first display region, in accordance with an input by a user. The computer selects some of the plurality of pieces of presentation information, and changes the presentation information to be selected, in accordance with change of a display of the presentation information in the first display region. The computer displays, in a second display region different from the first display region, the selected presentation information together with the virtual space such that the selected presentation information is associated with positions within the virtual space.

The phrase “change of a display of the presentation information in the first display region” means to include change of presentation information displayed in the first display region and change of a position of the presentation information displayed in the first display region. In other words, the computer may change the presentation information to be selected, in accordance with change of the presentation information displayed in the first display region by scrolling, switching a page, or the like. In addition, the computer may change the presentation information to be selected, in accordance with change of the position of the presentation information displayed in the first display region (e.g., change of presentation information displayed at the center of the first display region) by scrolling or enlargement/reduction.

According to the configuration of the above (1), of a plurality of pieces of presentation information set within the virtual space, some pieces of presentation information corresponding to the display in the first display region are displayed in the second display region. Therefore, even when a lot of presentation information is set within the virtual space, it is possible to display the presentation information such that the presentation information is easily viewable.

(2) A portion of a presentation information group image in which the plurality of pieces of presentation information are arranged may be displayed in the first display region. In this case, presentation information having a predetermined positional relation between a display range, displayed in the first display region, of the presentation information group image and a position of the presentation information on the presentation information group image, may be selected.

According to the configuration of the above (2), presentation information is selected on the basis of the positional relation between the display range, displayed in the first display region, of the presentation information group image and the position of the presentation information on the presentation information group image. Therefore, it is possible to select presentation information on the basis of its displayed position, such as to select presentation information whose displayed position is within a predetermined range on the screen. Accordingly, it is possible to select appropriate presentation information corresponding to a display situation of the first display region and to display the presentation information in the second display region.

(3) Presentation information may be selected under at least a condition of being displayed in the first display region.

According to the configuration of the above (3), it is possible to synchronize presentation information displayed in the first display region with presentation information displayed in the second display region, and thus it is possible to display the presentation information in a more easy-to-understand manner.

(4) Two or more pieces of presentation information may be selected from among the plurality of pieces of presentation information associated with the positions within the virtual space.

According to the configuration of the above (4), it is possible to present a plurality of pieces of presentation information in the second display region to the user at the same time.

(5) Non-selected presentation information of the plurality of pieces of presentation information associated with the positions within the virtual space may be displayed in the second display region in a form different from that of the selected presentation information, such that the non-selected presentation information is associated with a position within the virtual space.

According to the configuration of the above (5), since not only the selected presentation information but also the non-selected presentation information are displayed in the second display region, it is possible to also present the non-selected presentation information to the user. In addition, since the display forms are different between the selected presentation information and the non-selected presentation information, the user is allowed to easily distinguish both from each other.

(6) The selected presentation information may be displayed in such a display form that the selected presentation information is highlighted more than the non-selected presentation information, and/or in such a display form that more detailed information is presented than the non-selected presentation information.

According to the configuration of the above (6), it is possible to cause the user to pay attention to the selected presentation information rather than the non-selected presentation information. In addition, it is possible to display the selected presentation information such that the selected presentation information is easily viewable.

(7) A portion of an image in which the plurality of pieces of presentation information are arranged in a predetermined order may be displayed in the first display region. In this case, at least the non-selected presentation information may be displayed in such a display form that the predetermined order in the first display region is identifiable.

According to the configuration of the above (7), the user is allowed to recognize (infer) the arrangement of the presentation information displayed in the first display region, by viewing the second display region. Accordingly, the user is allowed to perform an operation of changing the presentation information displayed in the first display region, by referring to the second display region. For example, the second display region serves as a reference for how to perform the above operation when it is desired to display desired presentation information in the first display region. Therefore, with the configuration of the above (7), it is possible to allow the above operation to be more easily performed.

(8) Identification information with which each piece of presentation information is identifiable may be assigned to the plurality of pieces of presentation information. As an image representing the presentation information, an image including the identification information may be displayed in the first display region. For at least the non-selected presentation information, an image including the identification information may be displayed in the second display region.

According to the configuration of the above (8), regarding the non-selected presentation information, it is possible to cause the user to easily recognize at least correspondence between the presentation information displayed in the first display region and the presentation information displayed in the second display region. Accordingly, it is possible to display the presentation information in a more easy-to-understand manner.

(9) When the presentation information to be selected is changed, presentation information that becomes non-selected may be displayed in a display form changed from that when the presentation information is selected.

According to the configuration of the above (9), since the display form of the presentation information is switched in accordance with change of selection/non-selection, it is possible to inform the user, who views the second display region, of change of selection in an easy-to-understand manner.

(10) A portion of a list image in which the plurality of pieces of presentation information are arranged side by side may be displayed in the first display region.

According to the configuration of the above (10), it is possible to display the plurality of pieces of presentation information in the first display region in an easy-to-understand manner.

(11) The presentation information displayed in the first display region may be changed by moving a display range, displayed in the first display region, of the list image in accordance with an input by the user. In this case, an image, of the virtual space, in a range including the positions associated with the plurality of pieces of presentation information, respectively, may be displayed in the second display region.

According to the configuration of the above (11), in the first display region, since the display range is movable, it is possible to display presentation information with an easily viewable size. In addition, in the second display region, it is possible to display a lot of presentation information arranged in the virtual space. It is noted that when the configuration of the above (5) and the configuration of the above (11) are combined, it is possible to display, in the second display region, a lot of presentation information including the non-selected presentation information. Therefore, according to the configuration of the above (11), it is possible to display presentation information in the first display region such that the presentation information is easily viewable, and it is possible to display a lot of presentation information in the second display region. As a result, it is possible to display presentation information in an easy-to-understand manner.

(12) The second display region may be provided in a display device different from a display device in which the first display region is provided.

According to the configuration of the above (12), use of the two display devices allows presentation information to be provided to not only a single user but also a plurality of users such that the presentation information is easily viewable. In addition, even when one of the display devices cannot be viewed (or is difficult to view) by some users, it is possible to enjoy viewing presentation information by communication between a user who can view the one of the display devices and a user who has difficulty in viewing the one of the display devices.

(13) The information processing program may further cause the computer to execute displaying, in accordance with reception, from a user, a designation input of designating one piece of presentation information from among the presentation information displayed in the first display region, a first content image regarding the designated presentation information in the first display region, and displaying, in the second display region, a second content image that is a content image regarding the designated presentation information and is the same as or different from the first content image.

According to the configuration of the above (13), since the content images are displayed on the two display devices, it is possible to provide the content images to a plurality of users such that the content images are easily viewable. In addition, when the content images displayed on the two display devices are different from each other, it is possible to enjoy viewing two types of the content images regarding the presentation information.

(14) The information processing program may further cause the computer to execute performing, in accordance with an designation input of designating one piece of presentation information from among the presentation information displayed in the first display region, information processing associated with the designated presentation information.

According to the configuration of the above (14), the user is allowed to cause the information processing system to perform information processing associated with presentation information, by designating the presentation information.

(15) An image representing a map may be displayed as the virtual space in the second display region, and an image representing a point on the map may be displayed as the presentation information in the second display region so as to be associated with the point.

According to the configuration of the above (15), when information is presented together with a map so as to be associated with a position on the map, it is possible to display the presented information such that the presented information is easily viewable.

(16) A display range, displayed in the second display region, of the virtual space may be changed on the basis of the positions associated with the selected presentation information, such that each position is included in the display range.

According to the configuration of the above (16), for example, even when positions associated with a plurality of selected pieces of presentation information are concentrated in a part in the virtual space, it is possible to display the presentation information such that the presentation information is easily viewable.

In addition, the present specification discloses an information processing apparatus for presenting, together with a map, information associated with a position on the map. The information processing apparatus includes a first display control unit and a second display control unit. The first display control unit displays a portion of a list representing a plurality of pieces of information associated with positions on the map, in a first display region, and changes the portion of the list that is displayed in the first display region, in accordance with an input by a user. The second display control unit displays the map in a second display region different from the first display region and displays, in the second display region, some pieces of information selected from among information that is currently displayed in the first display region, such that the some pieces of information are associated with positions on the map. Information that is not currently displayed in the first display region is not displayed in the second display region or displayed in the second display region in a form different from that of the selected information.

It is noted that the present specification discloses an information processing apparatus and an information processing system each including the same means as each means realized by executing the information processing program in the above (1) to (16). In addition, the present specification discloses an information presentation method executed in the above (1) to (16).

According to the above storage medium having stored therein the information processing program, the above information processing system, the above information processing apparatus, and the above information presentation method, it is possible to display associated information such that the associated information is easily viewable by displaying selected presentation information such that the selected presentation information is associated with a position within the virtual space.

These and other objects, features, aspects and advantages will become more apparent from the following detailed description when taken in conjunction with the accompanying drawings.

### BRIEF DESCRIPTION OF THE DRAWINGS

FIG. 1 is a block diagram showing an example of a non-limiting information processing system according to an embodiment;

FIG. 2 is a diagram showing an example of an image displayed on a terminal apparatus when recommended spots are presented;

FIG. 3 is a diagram showing an example of a map image displayed on a television in a state shown in FIG. 2;

FIG. 4 is a diagram showing an example of an image displayed on the terminal apparatus when a display range of a list is changed from the state shown in FIG. 2;

FIG. 5 is a diagram showing an example of an image displayed on the television in a state shown in FIG. 4;

FIG. 6 is a diagram showing an example of displays on the terminal apparatus and the television when recommended spots to be selected are changed;

FIG. 7 is a diagram showing an example of a data structure of recommended spot data;

FIG. 8 is a flowchart showing an example of flow of a map display process performed by an information processing apparatus in the embodiment; and

FIG. 9 is a diagram showing an example of a map image displayed on the television in a modification of the embodiment.

### DETAILED DESCRIPTION OF NON-LIMITING EXAMPLE EMBODIMENTS

### 1. Configuration of Information Processing System

Hereinafter, an information processing program, an information processing system, an information processing apparatus, and an information presentation method according to an example of an embodiment will be described. FIG. 1 is a block diagram showing an example of the information processing system according to the present embodiment. In FIG. 1, an information processing system 1 includes an information processing apparatus 2, a terminal apparatus 3, and a television 4. The information processing system 1 according to the present embodiment displays information associated with a position on a map, on a display device (the terminal apparatus 3 and/or the television 4) together with the map.

The information processing system 1 includes the information processing apparatus 2. The information processing apparatus 2 performs information processing (a later-described map display process) performed in the information processing system 1. The information processing apparatus 2 may be an information processing apparatus in any form such as a personal computer, a game apparatus, a handheld terminal, or a smart phone. The information processing apparatus 2 is able to communicate with the terminal apparatus 3 and the television 4. It is noted that communication between the information processing apparatus 2 and the terminal apparatus 3 or the television 4 may be performed via a wire or wirelessly.

As shown in FIG. 1, the information processing apparatus 2 includes a CPU 11, a memory 12, and a program storage section 13. The CPU 11 performs the information processing by executing a predetermined information processing program using the memory 12. It is noted that the information processing apparatus 2 may have any configuration as long as the information processing apparatus 2 is able to perform the information processing, and, for example, a part or the entirety of the information processing may be performed by a dedicated circuit. In the present embodiment, the information processing apparatus 2 generates an image through the information processing, and the generated image is outputted from the information processing apparatus 2 to the terminal apparatus 3 and the television 4.

The program storage section 13 stores the information processing program. The program storage section 13 is any storage device that is accessible to the CPU 11. The program storage section 13 may be a storage section included in the information processing apparatus 2, such as a hard disk, or may be a storage medium attachable to and detachable from the information processing apparatus 2, such as an optical disc.

The information processing system 1 includes the terminal apparatus 3. The terminal apparatus 3 includes an LCD (liquid crystal display) 14 that is an example of a display unit. In the present embodiment, the terminal apparatus 3 is a portable (or handheld) display device. The terminal apparatus 3 receives an image transmitted from the information processing apparatus 2 and displays the image on the LCD 14.

The terminal apparatus 3 includes an input section 15. The input section 15 detects an operation of a user and outputs operation data representing the operation of the user. In other words, it can be said that the terminal apparatus 3 is an input device (controller). In the present embodiment, the terminal apparatus 3 includes operation buttons and a touch panel as the input section 15. The touch panel is provided on a screen of the LCD 14. It is noted that the input section 15 may include a sensor system capable of detecting an operation of moving the terminal apparatus 3, such as an attitude sensor (an acceleration sensor, a gyro-sensor, etc.). The terminal apparatus 3 transmits, to the information processing apparatus 2, the operation data outputted from the input section 15. In this manner, the information processing apparatus 2 is able to receive an input from the terminal apparatus 3, which is an input device.

As described above, in the present embodiment, the display device and the operation device are configured so as to be integrated with each other. However, in another embodiment, the display device and the operation device may be provided as separate devices.

The television 4 is an example of a display device which displays an image. The television 4 is an example of a stationary display device. When an image is transmitted from the information processing apparatus 2 to the television 4, the television 4 displays the image.

As described above, in the present embodiment, the information processing system 1 is configured to include two display devices. It is noted that in another embodiment, the information processing system 1 suffices to include at least one display device.

In the information processing system 1, the information processing apparatus 2 performs information processing (the display control process) in accordance with an input on the terminal apparatus 3, and an image obtained as a result of the performing of the information processing is displayed on the terminal apparatus 3 and the television 4. As described above, in the present embodiment, the information processing system 1 is configured such that an input function, an information processing function, and a display function are realized by a plurality of apparatuses. It is noted that in another embodiment, the information processing system 1 may be composed of a single information processing apparatus having these functions (e.g., a handheld or portable information processing apparatus). In addition, in another embodiment, the function of the information processing apparatus 2 may be realized by a plurality of apparatuses. For example, in another embodiment, at least a part of the information processing performed by the information processing apparatus 2 may be distributed to and performed by a plurality of apparatuses that are able to perform communication via a network (a wide-area network and/or a local network).

### 2. Display of Map Image

Next, a map display (presentation) method according to the present embodiment will be described. In the present embodiment, the information processing system 1 has a function to provide panoramic images at various locations of the world to the user. Here, the information processing system 1 uses a map when presenting, to the user, some recommended points (recommended spots) of points of which panoramic images are prepared. Hereinafter, a case will be described in which information on recommended spots is displayed on the map as information (presentation information) to be presented to the user together with the map.

(Display on Terminal Apparatus 3)

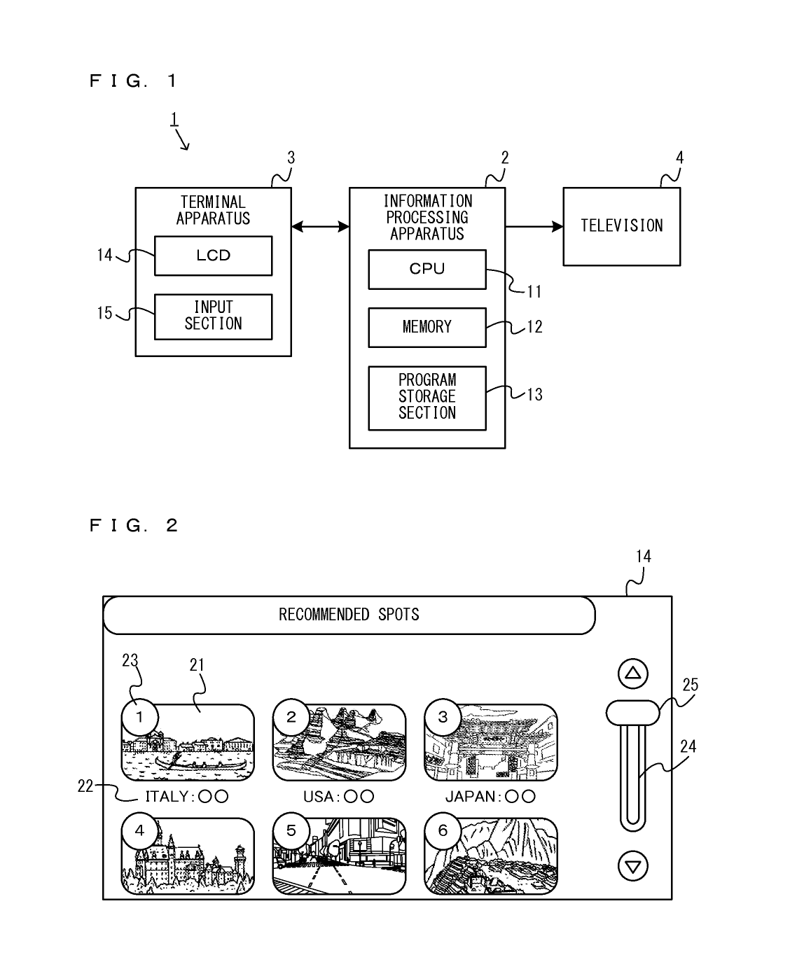

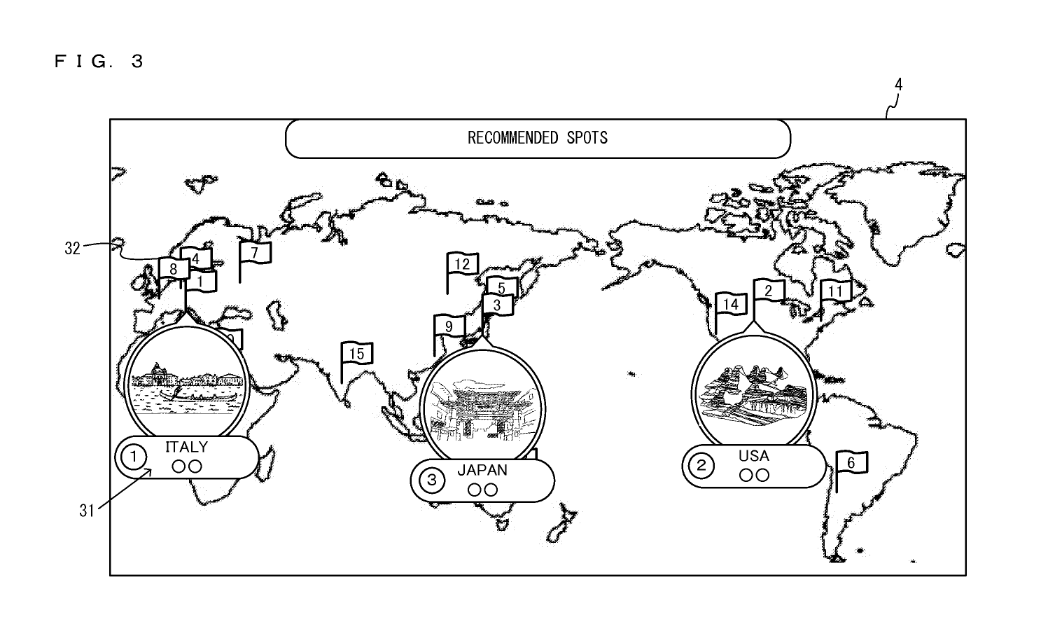

FIG. 2 is a diagram showing an example of an image displayed on the terminal apparatus 3 when recommended spots are presented. In addition, FIG. 3 is a diagram showing an example of an image displayed on the television 4 when recommended spots are presented. As shown in FIGS. 2 and 3, in the present embodiment, a map (world map) to which recommended spots are added is displayed on the television 4, and (a portion of) a list of the recommended spots is displayed on the LCD 14 of the terminal apparatus 3.

As shown in FIG. 2, a list of a plurality of recommended spots that are preset is displayed on the terminal apparatus 3. It can be said that the list is a presentation information group image in which a plurality of pieces of presentation information (information on recommended spots) are arranged. In addition, in the present embodiment, as shown in FIG. 2, the recommended spots are arranged in numerical order in the list. Thus, it can be said that the list is a list image in which presentation information is arranged in predetermined order.

In the present embodiment, in the list, as an image representing each recommended spot, a thumbnail image 21, a place name image 22, and a number image 23 are displayed for each recommended spot. The thumbnail image 21 is an image at a point in the recommended spot. In the present embodiment, the thumbnail image 21 is obtained from a panoramic image of the recommended spot. The place name image 22 indicates the place name of the recommended spot (it can also be said to be a position on the map). The number image 23 indicates a number assigned to each recommended spot. The number is identification information for identifying each recommended spot, and is previously assigned to each recommended spot in the present embodiment. It is noted that contents displayed as the images for the recommended spot are arbitrary. For example, in another embodiment, only one or two of the images 21 to 23 may be displayed, or an image indicating other information such as latitude/longitude information may be displayed in addition to (or instead of) the information represented by the images 21 to 23.

In addition, a portion of the list of the recommended spots is displayed on the terminal apparatus 3. Specifically, in the present embodiment, the list is displayed so as to be scrollable. It is noted that in the present embodiment, a scroll bar 24 and a scroll thumb 25 are displayed on the terminal apparatus 3 (see FIG. 2). The user is allowed to scroll the list up and down by an operation of moving the scroll thumb 25 up and down on the scroll bar 24. It is noted that an operation for scrolling the list may be any operation, and may be, for example, an operation with respect to the touch panel on the LCD 14 or an operation of inputting a direction with a cross key or a stick. In addition, a method for changing a display range of the list, namely, a method for changing displayed recommended spots of the recommended spots, is arbitrary. For example, in another embodiment, the displayed recommended spots may be changed by a method of switching a page. Moreover, in another embodiment, the displayed recommended spots may be changed by enlarging/reducing the display range of the list.

In a state shown in FIG. 2, recommended spots whose numbers are 1 to 3 are displayed at or near the center of the screen of the LCD 14 (at or near the center in a scroll direction, namely, in the up-down direction). Although a detailed description will be given later, the information processing system 1 selects some recommended spots displayed at or near the center of the screen (here, three recommended spots arranged side by side) from among the recommended spots included in the list in the present embodiment. For example, in the state shown in FIG. 2, the recommended spots whose numbers are 1 to 3 are selected. As described above, in the present embodiment, recommended spots to which attention is inferred to be currently paid by the user who views the terminal apparatus 3 are selected.

(Display on Television 4)

FIG. 3 is a diagram showing a map displayed on the television 4 in the state shown in FIG. 2. As shown in FIG. 3, in the above state, the selected recommended spots, namely, the recommended spots whose numbers are 1 to 3, are displayed so as to be associated with positions on the map. Specifically, as an image representing each selected recommended spot, a detailed image 31 of each selected recommended spot is displayed. The detailed image 31 indicates more detailed content regarding the recommended spot than a simple image 32 described later. As shown in FIG. 3, in the present embodiment, each detailed image 31 includes a thumbnail image, a place name image, and a number image that are the same as the images displayed on the terminal apparatus 3. It is noted that specific contents of each detailed image 31 are arbitrary. For example, in another embodiment, only one or two of the above three images may be displayed as each detailed image 31, or an image indicating other information may be displayed as each detailed image 31 in addition to (or instead of) the information represented by the above three images.

It is noted that although a detailed description will be given later, in the present embodiment, for the other recommended spots that have not been selected (the recommended spots whose numbers are numbers other than 1 to 3), simple images 32 are displayed so as to be associated with positions on the map. In the present embodiment, each simple image 32 is an image representing a flag and indicates the number of the recommended spot. In addition, in the present embodiment, for each selected recommended spot, both the detailed image 31 and the simple image 32 are displayed. In other words, in the present embodiment, for each currently selected recommended spot, the detailed image 31 and the simple image 32 are displayed on the map, and for each currently non-selected recommended spot, the simple image 32 is displayed. It is noted that in the present embodiment, the detailed images 31 are displayed more preferentially than the simple images 32, and thus some of the simple images 32 may be hidden by the detailed images 31 and not displayed.

(Change of Display in Accordance with Change of Recommended Spots to be Selected)

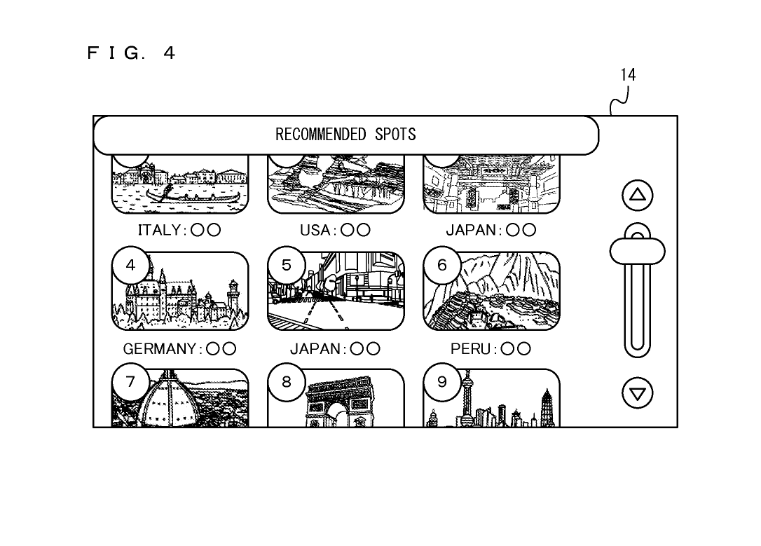

FIG. 4 is a diagram showing an example of an image displayed on the terminal apparatus 3 when the display range of the list is changed from the state shown in FIG. 2. As described above, the list displayed on the terminal apparatus 3 is scrollable, and when the list is scrolled, the recommended spots displayed at the center of the screen of the LCD 14 are changed. In FIG. 4, as a result of the list being scrolled downward from the state shown in FIG. 2, recommended spots whose numbers are 4 to 6 are displayed at the screen center. At that time, the information processing system 1 selects the recommended spots whose numbers are 4 to 6.

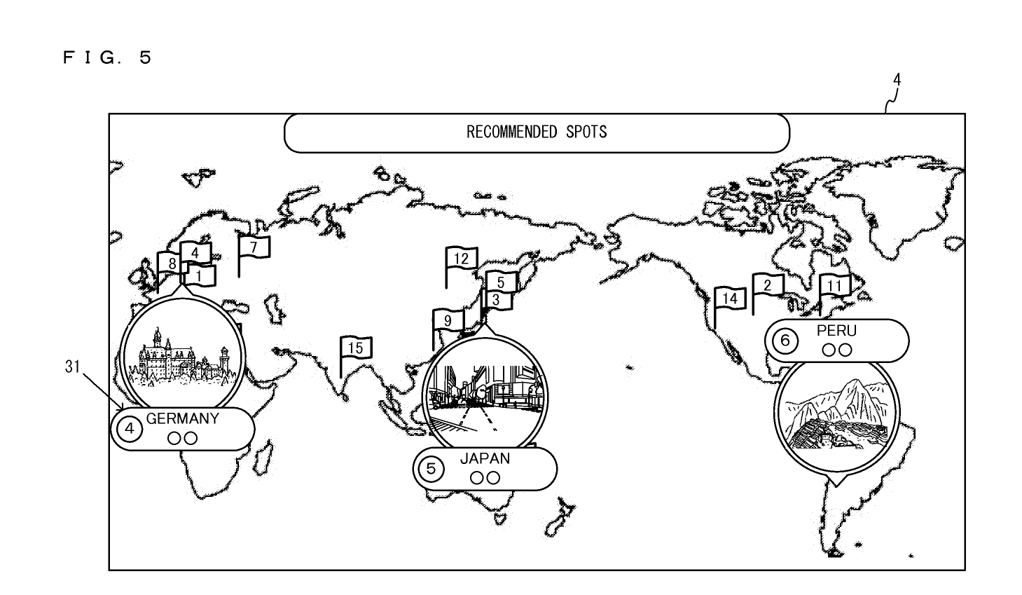

FIG. 5 is a diagram showing an example of an image displayed on the television 4 in a state shown in FIG. 4. As shown in FIG. 5, in the above state, for the recommended spots whose numbers are 4 to 6 and which are currently selected recommended spots, detailed images 31 are displayed. In other words, the recommended spots whose detailed images 31 are displayed are changed from the state shown in FIG. 3.

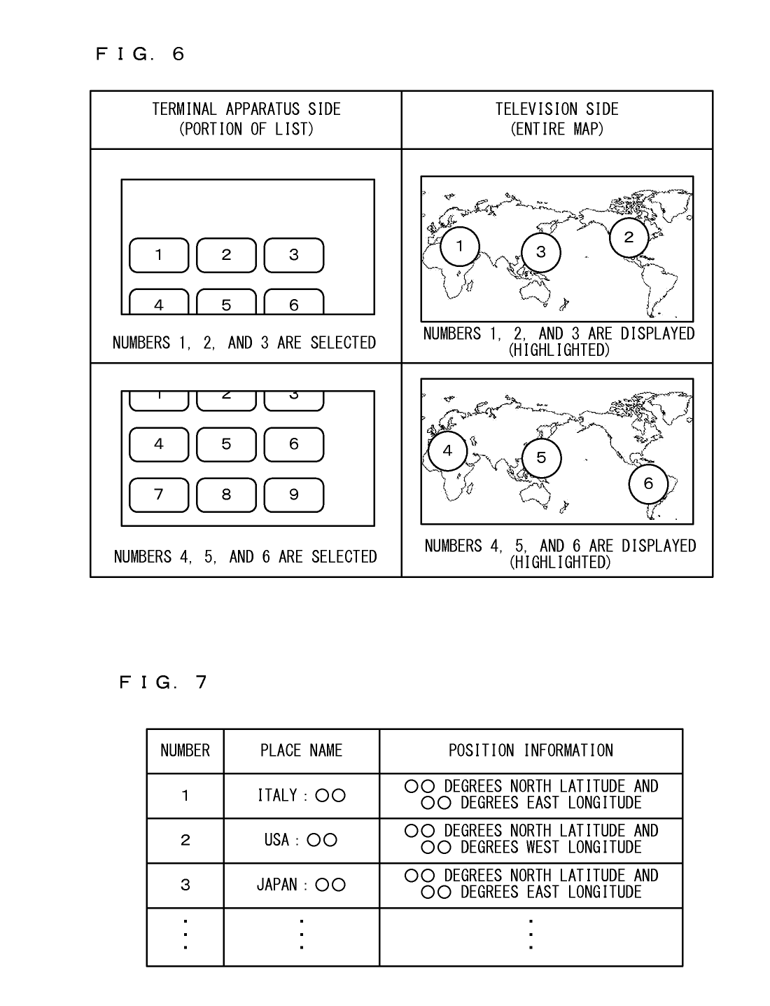

FIG. 6 is a diagram showing an example of displays on the terminal apparatus 3 and the television 4 when the currently selected recommended spots are changed. It is noted that in FIG. 6, for avoiding the drawing from being complicated, some images (the images 21 to 23, 31, and 32) are omitted as compared to FIGS. 2 to 5. As described above, in the present embodiment, the information processing system 1 causes some of a plurality of recommended spots associated with positions on the map (a portion of the list) to be displayed on the terminal apparatus 3 (FIGS. 2 and 4). In addition, by displaying the list such that the list is scrollable, the information processing system 1 changes the recommended spots displayed on the terminal apparatus 3, in accordance with an input by the user (the left part of FIG. 6). At that time, the information processing system 1 changes the recommended spots to be selected, in accordance with change of the display of the recommended spots on the terminal apparatus 3 (change of the recommended spots displayed at the screen center). Here, on the television 4, the detailed images 31 of the selected recommended spots are displayed together with the map so as to be associated with positions on the map (FIGS. 3 and 5 and the right part of FIG. 6).

As described above, according to the present embodiment, the detailed images 31 of some recommended spots, displayed on the terminal apparatus 3, among a plurality of recommended spots on the map are displayed on the television 4. Therefore, even when a lot of recommended spots are arranged on the map, it is possible to display the recommended spots such that the recommended spots are easily viewable.

(Difference in Presentation Information Between Currently Selected Recommended Spots and Currently Non-Selected Recommended Spots)

In the present embodiment, for each non-elected recommended spot, the simple image 32, which is an image representing a flag, is displayed (FIGS. 3 and 5). In other words, each non-elected recommended spot is displayed in a form different from those of the currently selected recommended spots. Thus, the non-selected recommended spots are also displayed on the map, and hence it is possible to also present information regarding the non-selected recommended spots to the user. For example, it is possible to cause the user to recognize that there are non-selected recommended spots and to roughly estimate the number of the recommended spots. In addition, since the non-selected recommended spots are displayed so as to be associated with the positions on the map, it is possible to inform the user where each recommended spot is located on the map.

It is noted that in the present embodiment, the simple image 32 is also displayed for each currently selected recommended spot, but in another embodiment, the simple image 32 may not be displayed for each currently selected recommended spot.

It is noted that in another embodiment, the information processing system 1 may not display the non-selected recommended spots on the map on the television 4. In other words, in the case where currently selected recommended spots are displayed on the map, it is possible to obtain the advantageous effect, “displaying each recommended spot such that each recommended spot is easily viewable”, by any of the following methods (a) and (b).

(a) A method in which images (the detailed images 31) representing the currently selected recommended spots are displayed, and images (the simple images 32) in a different display form are displayed for the currently non-selected recommended spots (a method according to the present embodiment)

(b) A method in which (images of) the currently selected recommended spots are displayed, and (images of) the currently non-selected recommended spots are not displayed.

Therefore, in the present embodiment, the case has been described in which the detailed images 31 are displayed as the currently selected recommended spots. However, in another embodiment, in the case of using the above method (b), the simple images 32 may be displayed as the currently selected recommended spots.

In addition, in the present embodiment, the selected recommended spots (the detailed images 31) are displayed on the television 4 in such a display form that the selected recommended spots are highlighted more than the non-selected recommended spots (the simple images 32) (FIGS. 3 and 5). Therefore, it is possible to cause the user to pay attention to the selected recommended spot. In addition, it is possible to display the selected recommended spots such that the selected recommended spots are easily viewable.

It is noted that in the present embodiment, the selected recommended spots (the detailed images 31) are displayed in such a display form that more detailed information is presented than the non-selected recommended spots (the simple images 32). Owing to this reason as well, similarly to the above, it is possible to cause the user to pay attention to the selected recommended spots. In addition, it is possible to provide more information regarding the selected recommended spots to the user.

In addition, in the present embodiment, the simple images 32 on the television 4 represent the numbers assigned to the recommended spots (FIGS. 3 and 5). Here, (a portion of) the list in which the recommended spots are arranged in order of these numbers is displayed on the terminal apparatus 3. Therefore, the non-selected recommended spots are displayed on the television 4 in such a display form that the order of the arrangement on the terminal apparatus 3 is identifiable. Accordingly, the user is allowed to recognize (infer) the arrangement of the recommended spots displayed on the terminal apparatus 3, by viewing the map on the television 4. For example, when the user desires to display a recommended spot that is not displayed on the terminal apparatus 3 at that time point, the user is allowed to determine how the screen of the terminal apparatus 3 is to be scrolled, on the basis of the simple images 32 arranged on the map on the television 4. Therefore, according to the above, an operation for selecting recommended spots on the terminal apparatus 3 (a scroll operation) is allowed to be more easily performed.

In addition, each of the above numbers is identification information with which each recommended spot is identifiable. Here, the detailed images 31 including the identification information (numbers) are displayed on the terminal apparatus 3, and the simple images 32 including the identification information (numbers) are displayed for the non-selected recommended spots on the television 4 as well. As described above, the recommended spots displayed on the terminal apparatus 3 and the recommended spots displayed on the television 4 are displayed so as to be associated with each other by the identification information. Accordingly, the user is allowed to easily recognize the correspondence between the recommended spots on the terminal apparatus 3 and the recommended spots on the television 4. Thus, the information processing system 1 is able to display the recommended spots in a more easy-to-understand manner.

In addition, in the present embodiment, the display form of the recommended spots that become non-selected as a result of the currently selected recommended spots being changed is changed (the right part of FIG. 6). In other words, whereas the detailed images 31 are displayed for the selected recommended spots, the simple images 32 are displayed for the recommended spots that become non-selected. In this manner, the display forms of the recommended spots (the images representing the recommended spots) are changed in accordance with change of selection/non-selection, and thus it is possible to inform the user, who views the television 4, of change of selection in an easy-to-understand manner.

(Method for Selecting Recommended Spots)

In the present embodiment, the information processing system 1 selects the recommended spots displayed at or near the center of the screen of the LCD 14 of the terminal apparatus 3 (see FIG. 6). In other words, the information processing system 1 selects the recommended spots each having a predetermined positional relation between the display range, displayed on the terminal apparatus 3, of the list and the position of the recommended spot on the list. It is noted that in the present embodiment, the predetermined positional relation is a positional relation in which the image representing the recommended spot is located at the center of the display range (in the up-down direction).

A specific method for selecting recommended spots is arbitrary. For example, a selection process may be performed by using the displayed position of each recommended spot on the screen of the LCD 14. That is, the information processing system 1 is able to determine whether to select each recommended spot, on the basis of whether the displayed position of the recommended spot is within a predetermined distance from the position of the center of the screen. In addition, for example, the selection process may be performed by using the position of the above display range on the list. That is, the information processing system 1 is able to identify the recommended spots displayed at the center of the screen, namely, recommended spots to be selected, on the basis of the position of the above display range on the list.

In the present embodiment, the information processing system 1 selects recommended spots under at least a condition of being displayed on the terminal apparatus 3 (see FIG. 6). Accordingly, for the recommended spots displayed on the terminal apparatus 3, (the detailed images 31 of) the recommended spots are displayed also on the television 4. That is, it is possible to synchronize the currently displayed recommended spots between the terminal apparatus 3 and the television 4, and it is possible to display the recommended spots in a more easy-to-understand manner.

As another example of the method for selecting recommended spots under at least the condition of being displayed on the terminal apparatus 3, there is the following method, for example. Specifically, in another embodiment, the information processing system 1 may select (all) recommended spots whose images (images 21 to 23) are at least partially displayed on the terminal apparatus 3. In addition, in another embodiment, the information processing system 1 may select recommended spots whose images are entirely displayed on the terminal apparatus 3.

In the present embodiment, the information processing system 1 selects recommended spots displayed in a range within a predetermined distance in the scroll direction of the list (here, in the up-down direction) from the center of the region where the list (which is a presentation information group image) is displayed, from among the recommended spots displayed on the terminal apparatus 3. Therefore, it is possible to select recommended spots to which attention is inferred to be paid by the user of the terminal apparatus 3 (to which attention is likely to be paid by the user of the terminal apparatus 3). Since the recommended spots to which attention is inferred to be paid by the user are displayed on the television 4, it is possible to provide effective information to the user by using the television 4. In addition, when another user views the television 4, it is possible to inform the other user which recommended spots the user of the terminal apparatus 3 pays attention to. It is noted that in another embodiment, in the case where the list is scrollable in the up-down direction and the left-right direction, the information processing system 1 may select recommended spots displayed in a range within a predetermined distance in the up-down direction and/or the left-right direction from the center of the display region of the list.

It is noted that attention is paid to the fact that selection of recommended spots by the information processing system 1 is different from designation of a recommended spot by the user for starting a reproduction process of a panoramic image. In the present embodiment, when a designation input of designating one of the recommended spots displayed on the terminal apparatus 3 is performed by the user, a display process of a panoramic image regarding the designated recommended spot is performed. Here, the above selection of recommended spots is performed in accordance with a display situation of the recommended spots on the terminal apparatus 3 (e.g., which recommended spots are displayed in a predetermined range (position) within the display region of the list), not depending on a designation input by the user. That is, the information processing system 1 does not select one recommended spot designated by the user, and selects two or more (three in the present embodiment) recommended spots from among a plurality of recommended spots associated with positions on the map, in accordance with the above display situation. Therefore, in the present embodiment, before the user performs a designation input, a plurality of recommended spots are selected, and the selected recommended spots are displayed on the television 4 so as to be associated with positions on the map (FIGS. 3 and 5). Accordingly, it is possible to present the recommended spots in an easy-to-understand manner before designation by the user, and an input of designating a recommended spot is made easy. It is noted that in another embodiment, one recommended spot may be selected in accordance with the above display situation.

(List Display and Map Display)

In the present embodiment, a list of a plurality of recommended spots that are preset is displayed on the terminal apparatus 3 so as to be scrollable. In other words, the information processing system 1 changes recommended spots displayed on the terminal apparatus 3, by moving a display range of the list in accordance with an input by the user. Therefore, in the terminal apparatus 3, recommended spots displayed on the screen of the LCD 14 at the same time are some recommended spots of the plurality of recommended spots that are preset. Meanwhile, in the television 4, the entirety of a map is displayed. In other words, the information processing system 1 displays, on the television 4, a map having a range including each position associated with each recommended spot. Therefore, it is possible to display, on the television 4, the plurality of recommended spots that are preset. Owing to the above, in the present embodiment, it is possible to display the recommended spots with easily viewable sizes on the terminal apparatus 3, and it is possible to display more recommended spots on the television 4. Thus, it is possible to present the plurality of recommended spots to the user in an easy-to-understand manner.

It is noted that in the case where the entirety of the map is displayed on the television 4, the center of the map may be changed. For example, in FIG. 3, the center of the map is near Japan, but may be changed such that another area is located at the center, in accordance with a predetermined condition. For example, when the map is displayed on the television 4 again after a recommended spot is designated by the user and a panoramic image is reproduced, the map may be displayed such that a point associated with a recommended spot designated the last time is located at the center.

In addition, in the present embodiment, the information processing system 1 displays the above list and the above map on two separate display devices, respectively. In other words, a display device (the terminal apparatus 3) in which a first display region where the list is displayed is provided, and a display device (the television 4) in which a second display region where the map is displayed is provided, are different from each other. Accordingly, for example, when a first user holds the terminal apparatus 3 and views recommended spots, a second user is allowed to know which recommended spots are displayed on the terminal apparatus 3, by viewing the television 4, and thus is allowed to know which recommended spots the first user views. Therefore, the users are allowed to discuss which recommended spots to designate, and are allowed to designate a recommended spot while communicating with each other. For example, even in the case where only the first user using the terminal apparatus 3 is allowed to perform a designation input, the second user is allowed to request the first user to designate a desired recommended spot. By selecting a recommended spot while communicating with each other as described above, the users are allowed to experience enjoyment of selection.

It is noted that in another embodiment, the information processing system 1 may be configured to include only one display device. In this case, the information processing system 1 may cause a list (i.e., an image displayed on the terminal apparatus 3 in the present embodiment) to be displayed in a first display region in the one display device, and may cause a map (i.e., an image displayed on the television 4 in the present embodiment) to be displayed in a second display region different from the first display region.

(Reproduction of Panoramic Image in Accordance with Designation of Recommended Spot)

In the present embodiment, the user is allowed to perform an input of designating one of the recommended spots displayed on the terminal apparatus 3. This input may be performed by any method, and, for example, is performed as an input of touching the screen of the LCD 14. It is noted that recommended spots that it is possible to designate may be all currently displayed recommended spots or only currently selected recommended spots.

When one recommended spot is designated by the user, the information processing system 1 performs information processing associated with the recommended spot. The content of this information processing is arbitrary, but in the present embodiment, it is a process of reproducing a panoramic image associated with the recommended spot. In the present embodiment, the information processing system 1 causes a panoramic image to be displayed on the terminal apparatus 3 and the television 4. In the present embodiment, a displayed content image is a panoramic image that is a still image, but in another embodiment, a panoramic moving image may be displayed as a content image.

In the present embodiment, while a panoramic image is reproduced, the information processing system 1 displays an image of a range, corresponding to a line-of-sight direction operated by the user, of the panoramic image on the terminal apparatus 3. In other words, the user is allowed to cause a desired panoramic image in the line-of-sight direction to be displayed on the terminal apparatus 3 by an operation with the terminal apparatus 3. In addition, the information processing system 1 displays an image of a range, corresponding to the line-of-sight direction directed in a certain direction, of the panoramic image on the television 4.

As described above, in the present embodiment, when a recommended spot is designated, a content image (panoramic image) regarding the designated recommended spot is displayed on the terminal apparatus 3, and a content image regarding the designated recommended spot is displayed on the television 4. In other words, the content images regarding the same recommended spot are displayed on the two display devices. Thus, a plurality of users are allowed to view and enjoy the content images regarding the same recommended spot. It is noted that the contents of the content images displayed on the respective display devices may be the same or different from each other. For example, as in the present embodiment, images, in different line-of-sight directions, of the same panoramic image may be displayed on the respective display devices.

### 3. Specific Example of Map Display Process

Hereinafter, a specific example of the map display process performed by the information processing system 1 (the information processing apparatus 2) in the present embodiment will be described. First, main data used in the map display process will be described. In the present embodiment, map data, recommended spot data, and panoramic image data are used in the map display process. In addition to these data, image data used for generating the images shown in FIGS. 2 to 5, and the like are used in the map display process.

The map data is data for generating a map (map image) to be displayed on the television 4. In addition, the panoramic image data is data of a panoramic image for which a viewpoint is at a position (point) on the map indicated by the map data. The panoramic image data is prepared for each of a plurality of points on the map, and each panoramic image data is associated with one of different points on the map.

The recommended spot data is data indicating information regarding preset recommended spots among each point on the map. FIG. 7 is a diagram showing an example of a data structure of the recommended spot data. As shown in FIG. 7, in the present embodiment, the recommended spot data is data in which the aforementioned number (identification information), place name information, and position information are associated with each other for each recommended spot. The place name information is information indicating the place name of each recommended spot. The position information is information indicating a position on the map.

It is noted that the CPU 11 of the information processing apparatus 2 may obtain these data (the map data, the recommended spot data, and the panoramic image data) from a storage section within the information processing apparatus 2, from a storage medium that is attachable to and detachable from the information processing apparatus 2, or from another apparatus via a network such as the Internet.

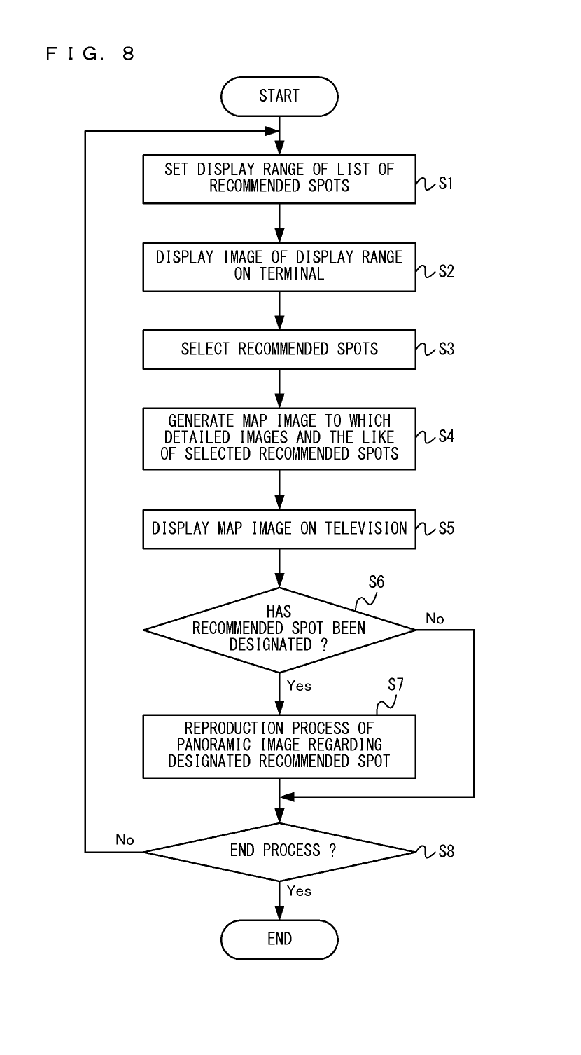

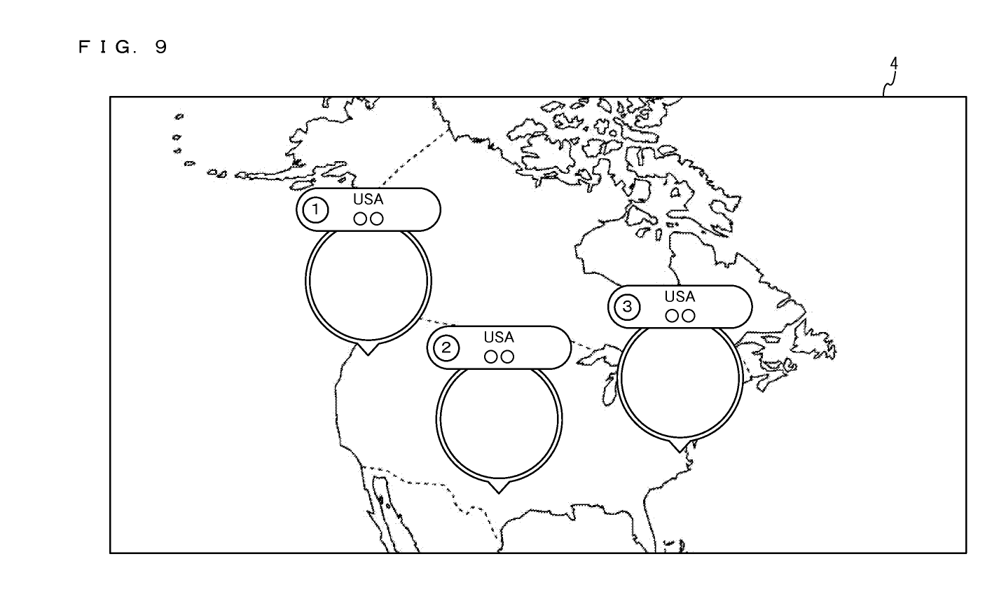

FIG. 8 is a flowchart showing an example of the map display process performed by the information processing apparatus 2 (the CPU 11) in the present embodiment. In the present embodiment, a series of processes shown in FIG. 8 is performed by the CPU 11 executing the information processing program stored in the program storage section 13.

It is noted that the timing at which the map display process shown in FIG. 8 is started is arbitrary. In the present embodiment, the information processing program is configured as a part of an application program for reproducing a panoramic image. In this case, the map display process shown in FIG. 8 is started in accordance with the user performing an instruction for starting the application program. In addition, a part or the entirety of the information processing program (application program) is loaded into the memory 12 at appropriate timing, and executed by the CPU 11. By so doing, the series of processes shown in FIG. 8 is started. It is noted that the information processing program (application program) has been previously stored in the program storage section 13 within the information processing apparatus 2. However, in another embodiment, the information processing program may be obtained by the information processing apparatus 2 from an attachable/detachable storage medium and stored into the memory 12, or may be obtained from another apparatus via a network such as the Internet and stored into the memory 12.

It is noted that a process in each step in the flowchart shown in FIG. 8 is merely an example, and as long as the same result is obtained, the order of the processes in the respective steps may be changed, or another process may be performed in addition to (or instead of) the process in each step. In addition, in the present embodiment, the CPU 11 performs the process in each step in the above flowchart. However, a processor or a dedicated circuit other than the CPU 11 may perform the processes at some of the steps in the above flowchart.

In addition, in the present embodiment, the CPU 11 obtains the aforementioned map data and recommended spot data before staring the map display process shown in FIG. 8. Moreover, the map data obtained before start of the map display process is only a part of data (e.g., data of some scale levels in the case where a plurality of scale levels are set in accordance with reduced scales). The obtained map data and recommended spot data are stored into the memory 12.

In step S1, the CPU 11 sets a display range of the above list of the recommended spots. In the present embodiment, the CPU 11 obtains operation data from the terminal apparatus 3 and controls the display range in accordance with an input by the user according to the method described above in “(Display on terminal apparatus 3)”. Recommended spots displayed on the terminal apparatus 3 are changed by change of the display range. Next to step S1, a process in step S2 is performed.

In step S2, the CPU 11 causes an image of the display range set in step S1 to be displayed on the terminal apparatus 3. More specifically, the CPU 11 generates an image of the display range and outputs (transmits) the generated image to the terminal apparatus 3. The terminal apparatus 3 receives the generated image and displays the generated image on the LCD 14. By so doing, a portion of the list is displayed on the LCD 14 (FIGS. 2 and 4). Next to step S2, a process in step S3 is performed.

In step S3, the CPU 11 selects recommended spots on the basis of the positions of the recommended spots displayed on the terminal apparatus 3. In the present embodiment, a plurality of (three in the present embodiment) recommended spots are selected according to the method described above in “(Method for selecting recommended spots)”. The CPU 11 stores, into the memory 12, selection data indicating the selected recommended spots (e.g., data indicating the above numbers). Next to step S3, a process in step S4 is performed.

In step S4, the CPU 11 generates a map image to be displayed on the television 4. In the present embodiment, a map image is generated according to the methods described above in “(Display on television 4)” and “(Difference in presentation information between currently selected recommended spots and currently non-selected recommended spots). Specifically, the CPU 11 reads the map data, the recommended spot data, and the selection data from the memory 12 and generates a map image using these data. It is noted that the detailed images 31 and the simple images 32 of the recommended spots are arranged so as to be associated with positions on the map which positions are associated with the recommended spots in the recommended spot data (in such a form as to indicate the positions). As a result of the process in step S4, in the generated map image, the detailed images 31 (and the simple images 32) are added for the selected recommended spots, and the simple images 32 are added for the non-selected recommended spots. Next to step S4, a process in step S5 is performed.

In step S5, the CPU 11 causes the map image generated in step S4 to be displayed on the television 4. More specifically, the CPU 11 outputs (transmits) the generated map image to the television 4. The television 4 receives and displays the generated map image thereon. By so doing, together with the map image, the selected recommended spots (the detailed images 31) and the like are displayed on the television 4 so as to be associated with the positions on the map (FIGS. 3 and 5). Next to step S5, a process in step S6 is performed.

In step S6, the CPU 11 determines whether a recommended spot has been designated by the user. In the present embodiment, the CPU 11 obtains operation data from the terminal apparatus 3, and performs the determination according to the method described above in “(Reproduction of panoramic image in accordance with designation of recommended spot)”. When a result of the determination in step S6 is positive, a process in step S7 is performed. On the other hand, when the result of the determination in step S6 is negative, the process in step S7 is skipped and a process in step S8 is performed.

In step S7, the CPU 11 performs a process of reproducing a panoramic image associated with the designated recommended spot. More specifically, the CPU 11 reads the recommended spot data from the memory 12 and identifies a position (point) on the map which is associated with the designated recommended spot in the recommended spot data. Then, the CPU 11 obtains panoramic image data associated with the identified position. By using the panoramic image data obtained thus, the panoramic image is displayed on each display device according to the method described above in “(Reproduction of panoramic image in accordance with designation of recommended spot)”. It is noted that in the present embodiment, the reproduction process of the panoramic image in step S7 is ended in accordance with an instruction by the user (e.g., an instruction for displaying the list of the recommended spots). In this case, when the map display process is not ended in the process in step S8 described later, The list is displayed again on the terminal apparatus 3, and the map image is displayed again on the television 4. After the process in step S7 is ended, the process in step S8 is performed.

In step S8, the CPU 11 determines whether to end the map display process. A specific method for this determination is arbitrary. For example, when an instruction for stopping execution of the application program is performed by the user, the CPU 11 determines to end the map display process, and when such an instruction by the user is not present, the CPU 11 determines to not end the map display process. When a result of the determination in step S8 is negative, the process in step S1 is performed again. Thereafter, the processes in steps S1 to S8 are repeatedly performed until it is determined in step S8 to end the display process. On the other hand, when the result of the determination in step S8 is positive, the CPU 11 ends the map display process shown in FIG. 8.

### 4. Modifications

### Modifications Regarding Displayed Virtual Space and Presentation Information

The information presentation method according to the embodiment describe above is applicable to a case where, together with a virtual space, arbitrary information is presented so as to be associated with a position within the virtual space. Specifically, in the embodiment described above, the information processing system 1 displays, as a virtual space, an image representing a map, and displays, as presentation information presented to the user, an image representing a point on the map (the images 21 to 23 representing information on each recommended spot) such that the image is associated with the point. However, in another embodiment, the displayed virtual space is not limited to the map and may be any type, and information displayed so as to be associated with the position within the virtual space is not limited to the information on the recommended spot and may be any type. For example, in another embodiment, the information processing system may arrange information including two-dimensional (or three-dimensional) numerical values, in a space having a two-dimensional (or three-dimensional) coordinate system.

(Modifications Regarding Map Display)

In the embodiment described above, the entirety of the map is displayed on the television 4, but a portion of the map may be displayed on the television 4 depending on a situation. FIG. 9 is a diagram showing an example of a map displayed on the television 4 in a modification of the present embodiment. For example, when three selected recommended spots are concentrated in a certain region on the map (e.g., in the North America region), the information processing system 1 may display the certain region in an enlarged manner (see FIG. 9). As described above, the information processing system 1 may change a display range, displayed on the television 4, of the map on the basis of each of positions associated with the selected recommended spots, such that each position is included in the display range. Accordingly, it is possible to display the recommended spots such that the recommended spots are easily viewable. It is noted that the method for changing the display range of the map on the basis of the positions of the selected recommended spots is not limited to enlarging/reducing the display range. For example, as another example of the method, a method is conceivable in which a portion of the map is set as a display range and the display range is moved on the basis of the positions of the selected recommended spots.

The systems, devices and apparatuses described herein may include one or more processors, which may be located in one place or distributed in a variety of places communicating via one or more networks. Such processor(s) can, for example, use conventional 3D graphics transformations, virtual camera and other techniques to provide appropriate images for display. By way of example and without limitation, the processors can be any of: a processor that is part of or is a separate component co-located with the stationary display and which communicates remotely (e.g., wirelessly) with the movable display; or a processor that is part of or is a separate component co-located with the movable display and communicates remotely (e.g., wirelessly) with the stationary display or associated equipment; or a distributed processing arrangement some of which is contained within the movable display housing and some of which is co-located with the stationary display, the distributed portions communicating together via a connection such as a wireless or wired network; or a processor(s) located remotely (e.g., in the cloud) from both the stationary and movable displays and communicating with each of them via one or more network connections; or any combination or variation of the above.

The processors can be implemented using one or more general-purpose processors, one or more specialized graphics processors, or combinations of these. These may be supplemented by specifically-designed ASICs (application specific integrated circuits) and/or logic circuitry. In the case of a distributed processor architecture or arrangement, appropriate data exchange and transmission protocols are used to provide low latency and maintain interactivity, as will be understood by those skilled in the art.

Similarly, program instructions, data and other information for implementing the systems and methods described herein may be stored in one or more on-board and/or removable memory devices. Multiple memory devices may be part of the same device or different devices, which are co-located or remotely located with respect to each other.

The embodiment described above is usable for an information processing system or the like for, for example, presenting information such that the information is associated with a position on a map, in order to display information presented together with a virtual space such that the information is easily viewable, for example.

While certain example systems, methods, devices and apparatuses have been described herein, it is to be understood that the appended claims are not to be limited to the systems, methods, devices and apparatuses disclosed, but on the contrary, are intended to cover various modifications and equivalent arrangements included within the spirit and scope of the appended claims.

What is claimed is:

1. An information processing apparatus for presenting, together with a map, information associated with a position on the map, the information processing apparatus comprising:
a first display control unit configured to display a portion of a list representing a plurality of pieces of information associated with positions on the map, in a first display region, and to change the portion of the list that is displayed in the first display region, in accordance with an input by a user; and
a second display control unit configured to display the map in a second display region different from the first display region and display, in the second display region, some pieces of information selected from among information that is currently displayed in the first display region, such that the some pieces of information are associated with positions on the map, wherein
information that is not currently displayed in the first display region is not displayed in the second display region or displayed in the second display region in a form different from that of the selected information.

2. A computer-readable non-transitory storage medium having stored therein an information processing program executed by a computer of an information processing apparatus for presenting information together with a virtual space such that the information is associated with a position within the virtual space, the information processing program causing the computer to execute:
displaying some of a plurality of pieces of presentation information associated with positions within the virtual space, in a first display region, and changing the presentation information displayed in the first display region, in accordance with an input by a user;
selecting some of the plurality of pieces of presentation information, and changing the presentation information to be selected, in accordance with change of a display of the presentation information in the first display region; and
displaying, in a second display region different from the first display region, the selected presentation information together with the virtual space such that the selected presentation information is associated with positions within the virtual space.

3. The storage medium according to claim 2, wherein
a portion of a presentation information group image in which the plurality of pieces of presentation information are arranged is displayed in the first display region, and
presentation information having a predetermined positional relation between a display range, displayed in the first display region, of the presentation information group image and a position of the presentation information on the presentation information group image, is selected.

4. The storage medium according to claim 2, wherein presentation information is selected under at least a condition of being displayed in the first display region.

5. The storage medium according to claim 2, wherein two or more pieces of presentation information are selected from among the plurality of pieces of presentation information associated with the positions within the virtual space.

6. The storage medium according to claim 2, wherein non-selected presentation information of the plurality of pieces of presentation information associated with the positions within the virtual space is displayed in the second display region in a form different from that of the selected presentation information, such that the non-selected presentation information is associated with a position within the virtual space.

7. The storage medium according to claim 6, wherein the selected presentation information is displayed in such a display form that the selected presentation information is highlighted more than the non-selected presentation information, and/or in such a display form that more detailed information is presented than the non-selected presentation information.

8. The storage medium according to claim 6, wherein
a portion of an image in which the plurality of pieces of presentation information are arranged in a predetermined order is displayed in the first display region, and
at least the non-selected presentation information is displayed in such a display form that the predetermined order in the first display region is identifiable.

9. The storage medium according to claim 6, wherein
identification information with which each piece of presentation information is identifiable is assigned to the plurality of pieces of presentation information,
as an image representing the presentation information, an image including the identification information is displayed in the first display region, and
for at least the non-selected presentation information, an image including the identification information is displayed in the second display region.

10. The storage medium according to claim 6, wherein, when the presentation information to be selected is changed, presentation information that becomes non-selected is displayed in a display form changed from that when the presentation information is selected.

11. The storage medium according to claim 2, wherein a portion of a list image in which the plurality of pieces of presentation information are arranged side by side is displayed in the first display region.

12. The storage medium according to claim 11, wherein
the presentation information displayed in the first display region is changed by moving a display range, displayed in the first display region, of the list image in accordance with an input by the user, and
an image, of the virtual space, in a range including the positions associated with the plurality of pieces of presentation information, respectively, is displayed in the second display region.

13. The storage medium according to claim 2, wherein the second display region is provided in a display device different from a display device in which the first display region is provided.

14. The storage medium according to claim 13, wherein the information processing program further causes the computer to execute displaying, in accordance with reception, from a user, a designation input of designating one piece of presentation information from among the presentation information displayed in the first display region, a first content image regarding the designated presentation information in the first display region, and displaying, in the second display region, a second content image that is a content image regarding the designated presentation information and is the same as or different from the first content image.

15. The storage medium according to claim 2, wherein the information processing program further causes the computer to execute performing, in accordance with an designation input of designating one piece of presentation information from among the presentation information displayed in the first display region, information processing associated with the designated presentation information.

16. The storage medium according to claim 2, wherein an image representing a map is displayed as the virtual space in the second display region, and an image representing a point on the map is displayed as the presentation information in the second display region so as to be associated with the point.

17. The storage medium according to claim 2, wherein a display range, displayed in the second display region, of the virtual space is changed on the basis of the positions associated with the selected presentation information, such that each position is included in the display range.

18. An information processing apparatus for presenting information together with a virtual space such that the information is associated with a position within the virtual space, the information processing apparatus comprising:
a first display control unit configured to display some of a plurality of pieces of presentation information associated with positions within the virtual space, in a first display region, and to change the presentation information displayed in the first display region, in accordance with an input by a user;
a selection unit configured to select some of the plurality of pieces of presentation information, and to change the presentation information to be selected, in accordance with change of a display of the presentation information in the first display region; and
a second display control unit configured to display, in a second display region different from the first display region, the selected presentation information together with the virtual space such that the selected presentation information is associated with positions within the virtual space.

19. An information processing system for presenting information together with a virtual space such that the information is associated with a position within the virtual space, the information processing system comprising:
a first display control unit configured to display some of a plurality of pieces of presentation information associated with positions within the virtual space, in a first display region, and to change the presentation information displayed in the first display region, in accordance with an input by a user;
a selection unit configured to select some of the plurality of pieces of presentation information, and to change the presentation information to be selected, in accordance with change of a display of the presentation information in the first display region; and
a second display control unit configured to display, in a second display region different from the first display region, the selected presentation information together with the virtual space such that the selected presentation information is associated with positions within the virtual space.

20. An information presentation method executed by an information processing apparatus for presenting information together with a virtual space such that the information is associated with a position within the virtual space, the information presentation method comprising:
displaying some of a plurality of pieces of presentation information associated with positions within the virtual space, in a first display region, and changing the presentation information displayed in the first display region, in accordance with an input by a user;
selecting some of the plurality of pieces of presentation information, and changing the presentation information to be selected, in accordance with change of a display of the presentation information in the first display region; and
displaying, in a second display region different from the first display region, the selected presentation information together with the virtual space such that the selected presentation information is associated with positions within the virtual space.
